(19) United States
(12) Patent Application Publication
(10) Pub. No.: US 2026/0024310 A1
(43) Pub. Date: Jan. 22, 2026

(54) TRAFFIC SIGN DETECTION METHOD, DEVICE AND STORAGE MEDIUM

(71) Applicant: NANJING UNIVERSITY OF POSTS AND TELECOMMUNICATIONS, Nanjing (CN)

(72) Inventors: Dengyin ZHANG, Nanjing (CN); Jikai HE, Nanjing (CN); Dichen ZHENG, Nanjing (CN)

(21) Appl. No.: 19/025,519

(22) Filed: Jan. 16, 2025

Related U.S. Application Data
(63) Continuation of application No. PCT/CN2025/071455, filed on Jan. 9, 2025.

(30) Foreign Application Priority Data
Jul. 18, 2024 (CN) 2024109649872

(51) Int. Cl. G06V 10/764; G06V 10/774; G06V 10/80

(52) U.S. Cl. CPC G06V 10/764; G06V 10/774; G06V 10/806; G06V 2201/07

(57) ABSTRACT

The present application discloses a traffic sign detection method, including: obtaining an image of a traffic road to be detected; pre-processing the image of the traffic road; inputting the pre-processed image of the traffic road into a pre-trained traffic sign detection model, to obtain a classification result output by the traffic sign detection model; and marking a detected traffic sign based on the classification result of the traffic sign detection model, to output a marked traffic sign image.

### CROSS-REFERENCE TO RELATED APPLICATIONS

The present application claims priority to Chinese Patent Application No. 2024109649872, filed on Jul. 18, 2024, the entire disclosure of which is incorporated herein by reference.

### TECHNICAL FIELD

The present application belongs to the field of transportation scenarios, and particularly to a traffic sign detection method, a device and a storage medium.

### BACKGROUND

Traffic sign detection is a key computer vision task aimed at automatically identifying and locating traffic signs in images or videos to improve traffic safety and intelligent traffic management. This technology is widely used in the field of autonomous and advanced assisted driving, aiming at detecting potential risks, and is an important part of intelligent transportation. In real-world environments, traffic signs often has some characteristics such as small targets, complex backgrounds, and diverse size variations, leading to recognition difficulties, and drivers may miss or misjudge traffic signs, which can have a serious impact on vehicle safety. Therefore, fast and accurate recognition of traffic signs has become very important in transportation tasks.

The current target detection algorithms for traffic scenes mainly have two stages, the first stage is a detection algorithm stage based on traditional manual features, to distinguish mainly based on the shape and color of traffic signs, the second stage is a detection stage based on deep learning detection, in which feature learning through convolutional neural networks, can automatically learn features and has a strong feature expression ability and generalization, can be applied to a variety of scenes, and the detection speed is much faster and more accurate.

Target detection algorithms based on deep learning mainly have two categories, the first category is to generate candidate regions and then classify candidate regions, such as: You Only Look Once (YOLO), Single Shot MultiBox Detector (SSD), Convolutional Neural Network (CNN), etc.; the second category is to realize target detection through an end-to-end approach, such as the Detection Transformer (DETR) series, etc. DETR removes the artificial priori knowledge by introducing the transformer structure, and the network structure is simpler. Due to adding the self-attention mechanism in the coding process and increasing the global semantics, DETR has a good performance in large target detection, but DETR also has the problems of poor detection of small objects and long training time, and convergence difficulties.

### SUMMARY

An object of the present application is to provide a traffic sign detection method that constructs a traffic sign detection model on the basis of an RT-DETR network model, realizes the recognition of traffic signs in different traffic scenes, and improves the accuracy of the recognition results. The present application is realized by the following technical solutions.

In a first aspect, the present application provides a traffic sign detection method including:
obtaining an image of a traffic road to be detected;
pre-processing the image of the traffic road;
inputting the pre-processed image of the traffic road into a pre-trained traffic sign detection model, to obtain a classification result output by the traffic sign detection model; and
marking a detected traffic sign based on the classification result of the traffic sign detection model, to output a marked traffic sign image;
the traffic sign detection model uses an improved Real-Time Detection Transformer (RT-DETR) network model, wherein the improved RT-DETR network model is formed by replacing each of 5th to 7th layers of an original RT-DETR network model with a down-sampling feature extraction layer of a three-layer feature learning fusion module DualBlocks, and replacing each of 11th and 16th layers of the original RT-DETR network model with a dynamic up-sampling layer of a dynamic up-sampling operator Dysample;

each down-sampling feature extraction layer consists of a DualConv module, an average pooling module and a ReLu linear activation function, and each dynamic up-sampling layer includes a sampling point generator, a sampling device, and an interpolation function.

In one embodiment, the feature learning fusion module DualBlocks includes a first branch and a second branch, the first branch includes a plurality of DualConv modules connected in series, and the second branch includes DualConv modules connected in series and an average pooling module;
the feature learning fusion module DualBlocks is configured to:
in the first branch, perform a plurality of DualConv convolutions on a feature map with an input height H, a width W, and a number C of channels;
in the second branch, perform the DualConv convolution and an average pooling sequentially on the feature map with the input height H, the width W, and the number C of channels;
splice the feature maps output from the first branch and the second branch together and process the spliced feature map through the ReLu linear activation function to obtain a feature map with a height H/2, a width W/2, and a number 2C of channels.

In one embodiment, the DualConv module is configured to:
divide input feature maps into G groups, with a total number N of convolutional filters and a total number M of input feature mapping channels; and
divide the input feature mapping channels into G groups of M/G feature channels and divide the convolutional filters into G groups of N/G convolutional filters;
where each N/G filter contains the G groups of M/G input feature mapping channels,
sequentially perform a convolution operation of 3*3 convolution kernels and the convolution operation of 1*1 convolution kernels in parallel for the input feature maps in one M/G input feature mapping channel in the each N/G filter, and only perform a convolution operation of 1*1 convolution kernels for the input feature maps in other channels; and
sequentially superimpose an output result of each group to obtain a final convolution result.

In one embodiment, the dynamic up-sampling operator Dysample is configured to:
for an input feature map;
in a first branch, select a suitable way of generating sampling points by a sampling point generator for the input feature map, and control a specific size of the feature map to be generated by a sampling device to determine a number of sampling points to be inserted;
in a second branch, enlarge a size of the input feature map, place features of an original image to corresponding positions, and empty positions of the sampling points to be inserted; and
insert generated sampling points into the corresponding positions by the first branch and the second branch through the interpolation function.

In one embodiment, the sampling point generator includes a static sampling point generator and a dynamic sampling point generator;
where the static sample point generator is configured to control the generation of a static range factor, the static range factor is generated as an input feature first passing through a linear layer with numbers C of input channels and numbers 2s² of output channels, respectively, to generate an offset O of size 2s²*H*W, wherein H and W are a height and a width of the input feature map, respectively, and s represents a size change factor in the dynamic up-sampling operator Dysample; and
multiply the offset O by a specific parameter and then reshape the size of the offset O to 2*sH*sW by pixel shuffling, and generate a sampling set δ by combining the offset O whose size is reshaped with an original grid G; and
where the dynamic state sample point generator is configured to control the generation of a dynamic range factor, wherein the dynamic range factor is first passed, by the first branch, through the linear layer with with numbers C of input channels and numbers 2s2 of output channels, respectively, to generate the offset O with the size of 2s2*H*W; and
make the offset O to be an offset within theoretical boundary conditions through an activation function Sigmoid and a coefficient value of 0.5; and
combine the offset within theoretical boundary conditions with an offset O of the second branch;
reshape a size of the combined offset O to 2*sH*sW by pixel shuffling; and
generate the sampling set δ by combining the offset O whose size is reshaped with the original grid G.

In one embodiment, dynamic up-sampling operator Dysample implements point sampling by controlling an initial sampling position, adjusting the offset and grouping an up-sampling process.

In one embodiment, the dynamic up-sampling operator Dysample controlling the initial sampling position and adjusting the offset includes:
controlling the static initial sampling position and adjusting the offset; and
controlling the dynamic initial sampling position and adjusting the offset;
where controlling the static initial sampling position and adjusting the offset includes:
separating positions of the sampling points and generating the sampling points using a fixed offset distance;
where controlling the dynamic initial sampling position and adjusting the offset includes:
adopting a dynamic offset distance and an localized offset to generate the sampling points;
selecting a plurality of sampling points to be evenly distributed in a grid, and setting offsets of the sampling points to a uniform standard;
where grouping the up-sampling process includes:
dividing the feature mapping channels into a plurality of groups along the channel dimension, wherein each group of the feature mapping channels performs operations of controlling the initial sampling position and adjusting the offset, to obtain the sampling points of the group and combine the sampling points of each group to obtain point sampling results.

In one embodiment, a method of training the traffic sign detection model includes:
obtaining traffic sign image samples and labeling information originating from different traffic environments;
dividing the traffic sign image samples into training set samples and test set samples;
pre-processing the traffic sign image samples to determine traffic sign image labeling information;
inputting the pre-processed training set samples and test machine samples into the pre-constructed RT-DETR network for training; and
detecting a classification accuracy of the trained RT-DETR network by the test set samples, and stopping the training when the classification accuracy meets a preset accuracy requirement, otherwise continuing the training of the RT-DETR network by the training set samples.

In a second aspect, the present application provides a traffic sign detection device, including:
an image acquisition module, configured for obtaining an image of a traffic road to be detected;
a pre-processing module, configured for pre-processing the image of the traffic road;
an image detection module, configured for inputting the pre-processed image of the traffic road into a pre-trained traffic sign detection model, to obtain a classification result output by the traffic sign detection model;
a detection result output module, configured for marking a detected traffic sign based on the classification result of the traffic sign detection model, to output a marked traffic sign image;
where the traffic sign detection model uses an improved Real-Time Detection Transformer (RT-DETR) network model, where the improved RT-DETR network model is formed by replacing each of 5th to 7th layers of an original RT-DETR network model with a down-sampling feature extraction layer of a three-layer feature learning fusion module DualBlocks, and replacing each of 11th and 16th layers of the original RT-DETR network model with a dynamic up-sampling layer of a dynamic up-sampling operator Dysample;
where each down-sampling feature extraction layer consists of a DualConv module, an average pooling module and a ReLu linear activation function, and each dynamic up-sampling layer includes a sampling point generator, a sampling device, and an interpolation function.

In a third aspect, the present application provides a computer-readable storage medium, on which computer-executable instructions are stored, wherein the computer-executable instructions, when executed by a processor implements steps of the traffic sign detection method as mentioned in the first aspect.

Based on the RT-DETR network model, the present application firstly introduces a feature learning fusion module DualBlocks, which enables the extraction network to help deeper convolutional layers to effectively extract shallow information by combining multiple small convolutional kernels and grouped convolutions, and reduces the number of network parameters under the condition of accuracy enhancement; secondly, a dynamic up-sampling operator Dysample is introduced, which recovers up-sampling features from a viewpoint of point sampling, saving more resources; a traffic sign detection model is constructed based on the improved RT-DETR network model, which has fewer network parameters and less computation compared with the original RT-DETR network model, and maintains a higher accuracy and detection speed.

### BRIEF DESCRIPTION OF THE DRAWINGS

FIG. 1 is a flowchart of the traffic sign detection method of the present application.

FIG. 2 is a structural diagram of the feature learning fusion module DualBlocks used in the method of the present application.

FIG. 3 is a principle schematic diagram of DualConv in the feature learning fusion module DualBlocks.

FIG. 4 is a structural diagram of the dynamic up-sampling operator Dysample.

FIG. 5 is a schematic diagram of a sampling point generator in the dynamic dynamic up-sampling operator.

FIG. 6 is a schematic diagram of setting of the static initial sampling point and offset distance.

FIG. 7 is a schematic diagram of setting of the dynamic initial sampling point and offset distance.

FIG. 8 is a structural diagram of an improved RT-DETR network model of the present application.

FIG. 9 is a detection effect of the improved RT-DETR network model of the present application.

### DETAILED DESCRIPTION OF THE EMBODIMENTS

The following description is further described in conjunction with the accompanying drawings and specific embodiments. In the description of the present application, it is to be understood that the terms “first”, “second”, and the like are used only for descriptive purposes, and are not to be understood as indicating or implying relative importance or implicitly specifying the number of the indicated technical features. Accordingly, a feature defined with the terms “first”, “second”, etc. may expressly or implicitly include one or more such features.

First embodiment, the present application provides a traffic sign detection method, including:
obtaining an image of a traffic road to be detected;
pre-processing the image of the traffic road;
inputting the pre-processed image of the traffic road into a pre-trained traffic sign detection model, to obtain a classification result output by the traffic sign detection model; and
marking a detected traffic sign based on the classification result of the traffic sign detection model, to output a marked traffic sign image;
where the traffic sign detection model uses an improved Real-Time Detection Transformer (RT-DETR) network model, wherein the improved RT-DETR network model is formed by replacing each of 5th to 7th layers of an original RT-DETR network model with a down-sampling feature extraction layer of a three-layer feature learning fusion module DualBlocks, and replacing each of 11th and 16th layers of the original RT-DETR network model with a dynamic up-sampling layer of a dynamic up-sampling operator Dysample;
where each down-sampling feature extraction layer consists of a DualConv module, an average pooling module and a ReLu linear activation function, and each dynamic up-sampling layer includes a sampling point generator, a sampling device, and an interpolation function.

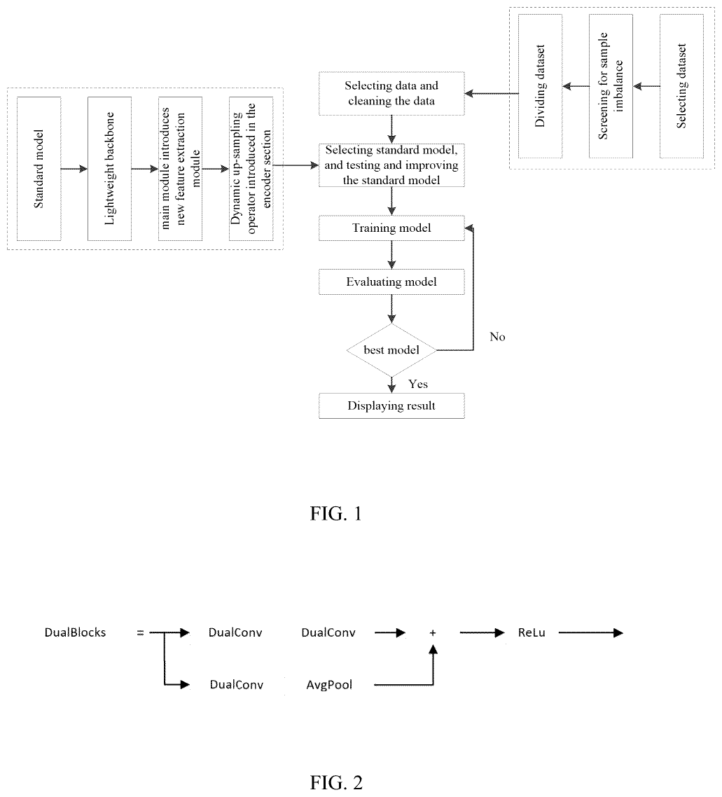

In practical application, the overall process is shown in FIG. 1, firstly, the traffic sign dataset is selected, the dataset is cleaned for the uneven distribution of the dataset samples, and then the standard network model is selected to be improved, and the pre-processed dataset is trained and evaluated by the improved network model, and the optimal network model is determined based on the value of the loss function and the accuracy of the recognition, and then the pre-processed dataset is evaluated to get the final results.

The present embodiment mainly involves the following.

### I Acquisition and Processing of the Dataset

The dataset selected for the present application is the traffic sign dataset TT100K, which is a public dataset containing 221 traffic sign categories, but the number of instances of many categories is small due to the uneven number of signs. The present application selects the traffic sign categories in which the number of instances of traffic signs in each category in the dataset is greater than 50 and cleans the dataset for the uneven distribution of samples in the dataset, and finally filters out 7963 pictures, a total of 45 categories, which are partitioned into a training set and a test set in accordance with 4:1, and carries out the model training and testing on the basis of the training set and the test set.

### II the Construction and Training of the Model

### 2.1 Construction of Traffic Sign Detection Model

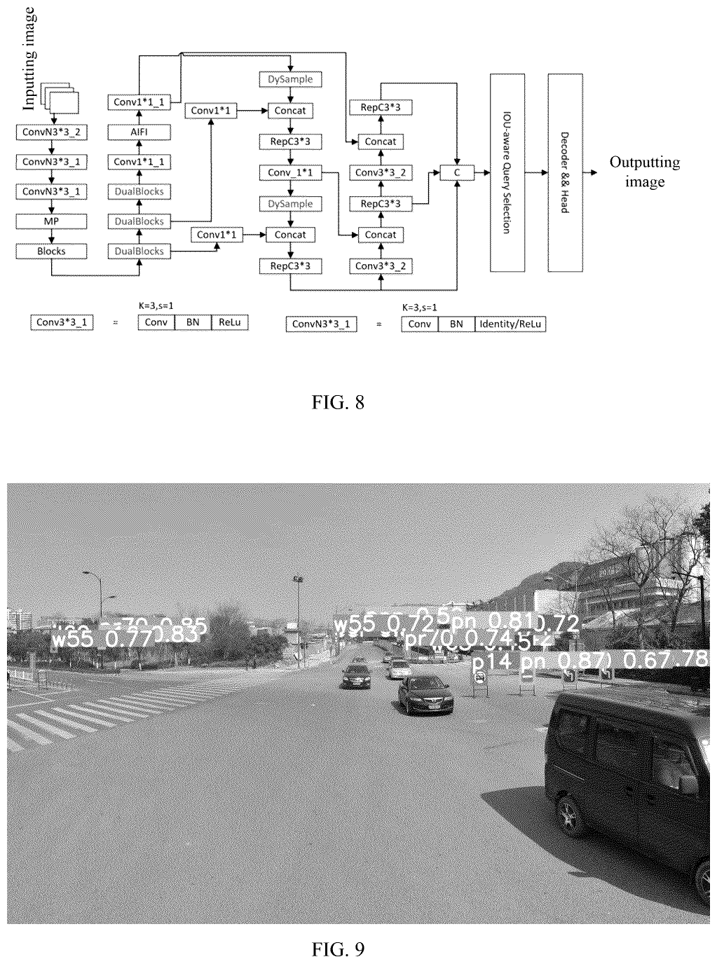

In this embodiment, the traffic sign detection model adopts the improved Real-Time Detection Transformer (RT-DETR) network model, as shown in FIG. 8, based on the RT-DETR network model, three layers of feature learning fusion module DualBlocks downsampling feature extraction layer are added between 4th to 8th layers, each layer consists of a DualConv module, an average pooling module, and a ReLu linear activation function, an up-sampling layer of the dynamic up-sampling operator Dysample is added between 10th and 11th layers of the RT-DETR network model, each layer includes a sampling point generator, a sampling device, and an interpolation function, and an up-sampling layer of the dynamic up-sampling operator Dysample is also added between 15th to 17th layers of the RT-DETR network model.

As shown in FIG. 2, the feature learning fusion module DualBlocks includes a first branch and a second branch, the first branch comprises a plurality of DualConv modules connected in series, and the second branch includes DualConv modules connected in series and an average pooling module; the feature learning fusion module DualBlocks is configured to: in the first branch, perform a plurality of DualConv convolutions on a feature map with an input height H, a width W, and a number C of channels; in the second branch, perform the DualConv convolution and an average pooling sequentially on the feature map with the input height H, the width W, and the number C of channels; and splice the feature maps output from the first branch and the second branch together and process the spliced feature map through the ReLu linear activation function to obtain a feature map with a height H/2, a width W/2, and a number 2C of channels.

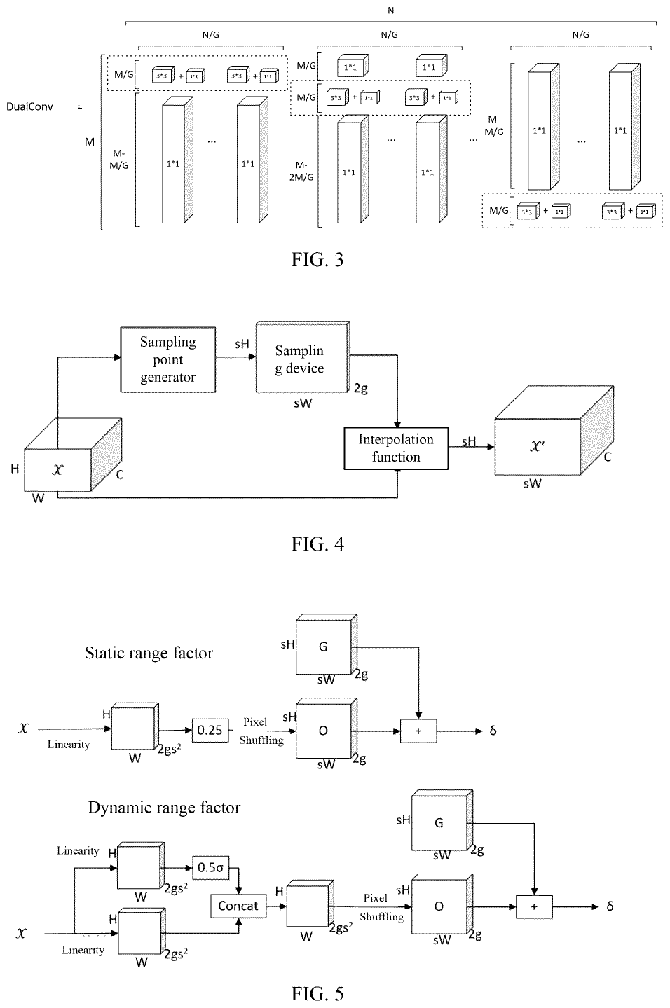

The strided Convolution in the original RT-DETR network model is replaced using DualConv convolution, which is a dual convolution scheme that combines the advantages of grouped convolution and non-uniform convolution. The DualConv convolution is configured to perform the following specific operations, as shown in FIG. 3, configured to divide input feature maps into G groups, with a total number N of convolutional filters and a total number M of input feature mapping channels; and to divide the input feature mapping channels into G groups of M/G feature channels and divide the convolutional filters into G groups of N/G convolutional filters; each N/G filter contains the G groups of M/G input feature mapping channels. The DualConv convolution sequentially performs a convolution operation of 3*3 convolution kernels and the convolution operation of 1*1 convolution kernels in parallel for the input feature maps in one M/G input feature mapping channel in the each N/G filter, and only performs a convolution operation of 1*1 convolution kernels for the input feature maps in other channels, such that the original information of the feature map is reserved and it helps the deeper convolutional layers to extract more effective features; and by such grouping convolutions, each convolution filter can extract information from only 1/G input feature channels, and an output result of each group is superimposed sequentially to obtain a final convolution result.

The original network model uses a nearest neighbor interpolation algorithm for up-sampling, where the nearest neighbor interpolation is a simple copy of the pixel values, which may result in jagged edges or distortion of the image, and can easily result in loss of extracted information when up-sampling is performed. The present application uses the dynamic up-sampling operator Dysample for recovery of up-sampling features, which customizes the up-sampling from the viewpoint of point sampling, saving more resource and easily implementing. The dynamic up-sampling operator Dysample up-samples the encoded image features, so that the image changes in size from a height H and a width W to a height 2H and a width 2W, with the number of channels remaining constant. The size change process makes the generated sampling points more relevant to the surrounding nodes. As shown in FIG. 4, the dynamic up-sampling operator Dysample performs the following specific operations: for the input feature map x, in the first branch, the input feature map is first passed through a sampling point generator to select a suitable sampling point generation method, to determine the value of the generated sampling points, and then the specific dimensions of the feature map to be generated is controlled by a sampling device, to ensure the generation of the expected image size, and to determine the number of sampling points to be inserted; in the second branch, the size of the input feature map is enlarged, the features of the original image are placed to the corresponding positions to ensure that they will not be distorted, and the positions of the sampling points to be inserted are emptied; and finally, these two branches are used to insert the generated sampling points to the corresponding positions through the interpolation function, to generate the up-sampling features x′ of the image. In FIG. 4, s represents the size change factor in the dynamic up-sampling operator Dysample, and s takes the value of 2 in this embodiment.

The sampling point generator in FIG. 4 includes a static sampling point generator and a dynamic sampling point generator, as shown in FIG. 5.

The static sample point generator is configured to control the generation of a static range factor, the static range factor is generated as an input feature first passing through a linear layer with numbers C of input channels and numbers 2s² of output channels, respectively, to generate an offset O of size 2s2*H*W, H and W are a height and a width of the input feature map, respectively, and s represents a size change factor in the dynamic up-sampling operator Dysample, and in this embodiment, s takes the value of 2. The offset O is multiplied by a specific parameter 0.25, which exactly satisfies the theoretical marginal condition between overlap and non-overlap, and then the size of the offset O to 2*sH*sW by pixel shuffling is reshaped, and a sampling set δ is generated by combining the offset O whose size is reshaped with an original grid G.

The dynamic state sample point generator is configured to control the generation of a dynamic range factor, the dynamic range factor is first passed, by the first branch, through the linear layer with with numbers C of input channels and numbers 2s² of output channels, respectively, to generate the offset O with the size of 2s²*H*W; and the offset O is made to be an offset within theoretical boundary conditions through an activation function Sigmoid and a coefficient value of 0.5, in FIG. 5, δ is the function Sigmoid; and the offset within theoretical boundary conditions is combined with an offset O of the second branch; a size of the combined offset O is reshaped by pixel shuffling to 2*sH*sW; and the sampling set δ is generated by combining the offset O whose size is reshaped with the original grid G.

The sampling point generator gives more priority to geometrically more isolated points, such that the algorithm is particularly suitable for non-uniformly distributed data features, and the use of the sampling point generator in the present application allows for a smoother articulation of the sampling points on the image after sampling, reducing jagged appearances and noise amplification.

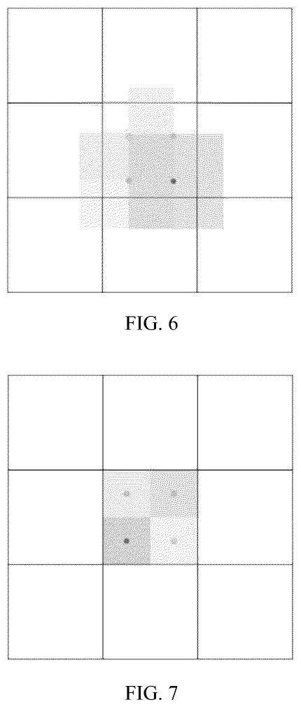

Dynamic up-sampling operator Dysample specifically realizes point sampling by controlling the initial sampling position, adjusting the offset and grouping up-sampling process. The original sampling position is to set the sampling point at the same position, adjust the offset range of the offset, so that the generated offset is different to get the value of the up-sampling, which will ignore the positional relationship of the neighboring points, so that the distribution of the initial sampling positions is uneven. If all offsets are 0 in a certain range, it will make the image after sampling appears to be a fault phenomenon. The static range factor determines the setting of initial sampling point and offset distance as shown in FIG. 6, the positions of the sampling points are separated and a fixed offset distance is used to generate the sampling point, which enables the sampling point generated from the image to have a larger sense of the field, to obtain greater information, and is more suitable for recovery of local large features. Dynamic range factor determines the setting of the initial sampling point and offset distance as shown in FIG. 7, dynamic offset distance and local offset are used to generate sampling points, four sampling points are selected to be uniformly distributed in a grid, the offsets of the sampling points are set to a uniform standard, so that the offsets don't overlap and produce cross influence, and the impact of the noise brought about by a larger sense of the field is reduced, it is suitable for the recovery of local small features. The grouping up-sampling process means dividing the feature mapping channels into g groups along the channel dimension and generating g groups of offsets. Each group of channel features respectively goes through the steps as in FIG. 4 to get the up-sampling map of that channel feature, and finally the feature generation maps of each group are combined sequentially to get the final up-sampling feature map.

### 2.2 Training of Traffic Sign Detection Model

The divided training set is input into the improved RT-DETR network model for training, and after each round of training, the test set is input into the model for evaluation. Repeating the above process to optimize the parameters of the improved RT-DETR network model continuously, and finally the trained model is obtained.

### 2.3 Experimentation

The training model in this embodiment is based on the Linux operating system, the programming language is Python 3.8, the deep learning framework is Pytorch 2.0.0, and Compute Unified Device Architecture (CUDA) is 11.8. The system is trained on a 4090 GPU with 24 GB of Random-Access Memory (RAM), with 200 training rounds, a batch size of 24, and using the Adam optimizer with an initial learning rate of 1*10-4.

The average accuracy, number of parameters, computation and detection speed of the improved model are counted on the test set to compare with the basic RT-DETR network model, and the results are shown in Table 1 below.

Where mAP is an average of precision rates under different recall rates, here is mAP@0.5, mAp (samll) is the average of precision rates under different recall rates generated using the Common Objects in Context (COCO) tool about small targets, the number of parameters is the sum of parameters generated by the overall network model passing through convolutional layers, pooling layers, etc., and Floating-Point Operations Per Second (FLOPS) is the number of parameters calculated after the overall network model passing through convolutional layers, pooling layers, etc., here G in Giga Floating—Point Operations Per Second (GFLOPS) means the number of parameters is in GB, Frames Per Second (FPS) is the frame rate of image processing, which is derived from the speed of processing each image here.

TABLE 1
Comparative results of adding evaluation indicators for different modules

| | | | | | Number of | | |
|---|---|---|---|---|---|---|---|
| | | | mAp@ | mAp | parameters/ | | |
| model | DySample | DualConv | 0.5 | (samll) | 106 | GFLOPs | FPS |
| RT-DETR | — | — | 0.8 | 0.538 | 20.1 | 57.8 | 32 |
| RT-DETR + | ✓ | | 0.811 | 0.540 | 20.1 | 57.8 | 43 |
| Dysample | | | | | | | |
| RT-DETR + | ✓ | ✓ | 0.816 | 0.548 | 16.1 | 50.5 | 44 |
| DualConv + | | | | | | | |
| Dysample | | | | | | | |

As can be seen from the results in Table 1, compared to the original RT-DETR network, the present application, after improving the network, introduces the DySample module, such that the number of parameters of the model increases only slightly, while the accuracy of the recognition and the speed of the detection improves by 10 frames, and after the DualConv convolution is added, the number of parameters of the model decreases by 4M, and the amount of computation decreases synchronously by 7.3, and it is guaranteed that the speed of the recognition does not decrease, the COCO toolkit is used to calculate the accuracy of mAp on small target objects, the improved modules effectively improve the detection accuracy of small targets, reflecting the superiority of the improved model.

### III. Practical Application

The image of the traffic road to be recognized is input into the trained model, and the traffic signs in the image are identified to detect the effectiveness of the traffic sign detection model, as shown in FIG. 9, which is the marking result of the traffic signs identified by the improved model from the image of the traffic road. If the model detects a traffic sign from the image of the traffic road, the traffic sign is marked with a rectangular box and the output image is saved.

The second Embodiment, based on the same inventive conception as the first embodiment, describes a traffic sign detection device, which includes:
an image acquisition module, configured for obtaining an image of a traffic road to be detected;
a pre-processing module, configured for pre-processing the image of the traffic road;
an image detection module, configured for inputting the pre-processed image of the traffic road into a pre-trained traffic sign detection model, to obtain a classification result output by the traffic sign detection model;
a detection result output module, configured for marking a detected traffic sign based on the classification result of the traffic sign detection model, to output a marked traffic sign image;
where the traffic sign detection model uses an improved Real-Time Detection Transformer (RT-DETR) network model, which is based on the RT-DETR network model, three layers of feature learning fusion module DualBlocks downsampling feature extraction layer are added between 4th to 8th layers, each layer consists of a DualConv module, an average pooling module, and a ReLu linear activation function, an up-sampling layer of the dynamic up-sampling operator Dysample is added between 10th and 11th layers of the RT-DETR network model, each layer includes a sampling point generator, a sampling device, and an interpolation function, and an up-sampling layer of the dynamic up-sampling operator Dysample is also added between 15th to 17th layers of the RT-DETR network model.

Third embodiment, based on the same inventive concept as the first embodiment and the second embodiment, describes a computer-readable storage medium, on which computer-executable instructions are stored, the computer-executable instructions, when executed by a processor implements steps of the traffic sign detection method as mentioned in the first embodiment and the second embodiment.

It should be appreciated by those skilled in the art that embodiments of the present application may be provided as methods, systems, or computer program products. Thus, the present application may take the form of a fully hardware embodiment, a fully software embodiment, or an embodiment that combines software and hardware aspects. Further, the present application may take the form of a computer program product implemented on one or more computer-usable storage media (including, but not limited to, disk memory, CD-ROM, optical memory, and the like) that contain computer-usable program code therein.

The present application is described with reference to flowcharts and/or block diagrams of methods, devices (systems), and computer program products according to embodiments of the present application. It is to be understood that each of the processes and/or boxes in the flowchart and/or block diagram, and the combination of processes and/or boxes in the flowchart and/or block diagram, may be implemented by computer program instructions. These computer program instructions may be provided to a processor of a general-purpose computer, a special-purpose computer, an embedded processor, or other programmable data-processing device to produce a machine, such that the instructions executed by the processor of the computer or other programmable data-processing device produce a device for carrying out the functions specified in the one process or multiple processes of the flowchart and/or in the one or more boxes of the box plot.

These computer program instructions may also be stored in a computer-readable memory and capable of directing a computer or other programmable data processing device to operate in a particular manner, such that the instructions stored in the computer-readable memory produce an article of manufacture including an instruction device that implements a function specified in one process or multiple processes of a flowchart and/or one box or multiple boxes of a block diagram.

These computer program instructions may also be loaded onto a computer or other programmable data processing device such that a series of operational steps are performed on the computer or other programmable device to produce computer-implemented processing, such that the instructions executed on the computer or other programmable device provide steps for implementing the functionality specified in the flowchart one process or a plurality of processes and/or the box diagram one box or a plurality of boxes.

The above embodiments of the present application are described in conjunction with the accompanying drawings, but the present application is not limited to the specific embodiments described above, which are merely illustrative and not limiting, and those skilled in the art, inspired by the present application and without departing from the scope of protection of the purposes of the present application and the claims, may make many other forms, which are all within the protection of the present application.

What is claimed is:

1. A traffic sign detection method, comprising:
obtaining an image of a traffic road to be detected;
pre-processing the image of the traffic road;
inputting the pre-processed image of the traffic road into a pre-trained traffic sign detection model, to obtain a classification result output by the traffic sign detection model; and
marking a detected traffic sign based on the classification result of the traffic sign detection model, to output a marked traffic sign image;
wherein the traffic sign detection model uses an improved Real-Time Detection Transformer (RT-DETR) network model, wherein the improved RT-DETR network model is formed by replacing each of 5th to 7th layers of an original RT-DETR network model with a down-sampling feature extraction layer of a three-layer feature learning fusion module DualBlocks, and replacing each of 11th and 16th layers of the original RT-DETR network model with a dynamic up-sampling layer of a dynamic up-sampling operator Dysample;
wherein each down-sampling feature extraction layer consists of a DualConv module, an average pooling module and a ReLu linear activation function, and each dynamic up-sampling layer comprises a sampling point generator, a sampling device, and an interpolation function.

2. The traffic sign detection method according to claim 1, wherein the feature learning fusion module DualBlocks comprises a first branch and a second branch, the first branch comprises a plurality of DualConv modules connected in series, and the second branch comprises DualConv modules connected in series and an average pooling module;
wherein the feature learning fusion module DualBlocks is configured to:
in the first branch, perform a plurality of DualConv convolutions on a feature map with an input height H, a width W, and a number C of channels;
in the second branch, perform the DualConv convolution and an average pooling sequentially on the feature map with the input height H, the width W, and the number C of channels;
splice the feature maps output from the first branch and the second branch together and process the spliced feature map through the ReLu linear activation function to obtain a feature map with a height H/2, a width W/2, and a number 2C of channels.

3. The traffic sign detection method according to claim 2, wherein the DualConv module is configured to:
divide input feature maps into G groups, with a total number N of convolutional filters and a total number M of input feature mapping channels; and
divide the input feature mapping channels into G groups of M/G feature channels and divide the convolutional filters into G groups of N/G convolutional filters;
wherein each N/G filter contains the G groups of M/G input feature mapping channels,
sequentially perform a convolution operation of 3*3 convolution kernels and the convolution operation of 1*1 convolution kernels in parallel for the input feature maps in one M/G input feature mapping channel in each N/G filter, and only perform a convolution operation of 1*1 convolution kernels for the input feature maps in other channels; and
sequentially superimpose an output result of each group to obtain a final convolution result.

4. The traffic sign detection method according to claim 1, wherein the dynamic up-sampling operator Dysample is configured to:
for an input feature map;
in a first branch, select a suitable way of generating sampling points by a sampling point generator for the input feature map, and control a specific size of the feature map to be generated by a sampling device to determine a number of sampling points to be inserted;
in a second branch, enlarge a size of the input feature map, place features of an original image to corresponding positions, and empty positions of the sampling points to be inserted; and
insert generated sampling points into the corresponding positions by the first branch and the second branch through the interpolation function.

5. The traffic sign detection method according to claim 4, wherein the sampling point generator comprises a static sampling point generator and a dynamic sampling point generator;
wherein the static sample point generator is configured to control the generation of a static range factor, the static range factor is generated as an input feature first passing through a linear layer with numbers C of input channels and numbers 2s² of output channels, respectively, to generate an offset O of size 2s²*H*W, wherein H and W are a height and a width of the input feature map, respectively, and s represents a size change factor in the dynamic up-sampling operator Dysample; and
multiply the offset O by a specific parameter and then reshape the size of the offset O to 2*sH*sW by pixel shuffling, and generate a sampling set δ by combining the offset O whose size is reshaped with an original grid G; and
wherein the dynamic state sample point generator is configured to control the generation of a dynamic range factor, wherein the dynamic range factor is first passed, by the first branch, through the linear layer with numbers C of input channels and numbers 2s² of output channels, respectively, to generate the offset O with the size of 2s2*H*W; and
make the offset O to be an offset within theoretical boundary conditions through an activation function Sigmoid and a coefficient value of 0.5; and
combine the offset within theoretical boundary conditions with an offset O of the second branch;
reshape a size of the combined offset O to 2*sH*sW by pixel shuffling; and
generate the sampling set δ by combining the offset O whose size is reshaped with the original grid G.

6. The traffic sign detection method according to claim 4, wherein dynamic up-sampling operator Dysample implements point sampling by controlling an initial sampling position, adjusting the offset and grouping an up-sampling process.

7. The traffic sign detection method according to claim 6, wherein the dynamic up-sampling operator Dysample controlling the initial sampling position and adjusting the offset comprises:
controlling the static initial sampling position and adjusting the offset; and
controlling the dynamic initial sampling position and adjusting the offset;
wherein controlling the static initial sampling position and adjusting the offset comprises:
separating positions of the sampling points and generating the sampling points using a fixed offset distance;
wherein controlling the dynamic initial sampling position and adjusting the offset comprises:
adopting a dynamic offset distance and a localized offset to generate the sampling points;
selecting a plurality of sampling points to be evenly distributed in a grid, and setting offsets of the sampling points to a uniform standard;
wherein grouping the up-sampling process comprises:
dividing the feature mapping channels into a plurality of groups along the channel dimension, wherein each group of the feature mapping channels performs operations of controlling the initial sampling position and adjusting the offset, to obtain the sampling points of the group and combine the sampling points of each group to obtain point sampling results.

8. The traffic sign detection method according to claim 7, wherein a method of training the traffic sign detection model comprises:
obtaining traffic sign image samples and labeling information originating from different traffic environments;
dividing the traffic sign image samples into training set samples and test set samples;
pre-processing the traffic sign image samples to determine traffic sign image labeling information;
inputting the pre-processed training set samples and test machine samples into the pre-constructed RT-DETR network for training; and
detecting a classification accuracy of the trained RT-DETR network by the test set samples, and stopping the training when the classification accuracy meets a preset accuracy requirement, otherwise continuing the training of the RT-DETR network by the training set samples.

9. A traffic sign detection device, comprising:
an image acquisition module, configured for obtaining an image of a traffic road to be detected;
a pre-processing module, configured for pre-processing the image of the traffic road;
an image detection module, configured for inputting the pre-processed image of the traffic road into a pre-trained traffic sign detection model, to obtain a classification result output by the traffic sign detection model;
a detection result output module, configured for marking a detected traffic sign based on the classification result of the traffic sign detection model, to output a marked traffic sign image;
wherein the traffic sign detection model uses an improved Real-Time Detection Transformer (RT-DETR) network model, wherein the improved RT-DETR network model is formed by replacing each of 5th to 7th layers of an original RT-DETR network model with a down-sampling feature extraction layer of a three-layer feature learning fusion module DualBlocks, and replacing each of 11th and 16th layers of the original RT-DETR network model with a dynamic up-sampling layer of a dynamic up-sampling operator Dysample;
wherein each down-sampling feature extraction layer consists of a DualConv module, an average pooling module and a ReLu linear activation function, and each dynamic up-sampling layer comprises a sampling point generator, a sampling device, and an interpolation function.

10. A computer-readable storage medium, on which computer-executable instructions are stored, wherein the computer-executable instructions, when executed by a processor implements steps of the traffic sign detection method as claimed in claim 1.
